(19) United States
(12) Patent Application Publication
(10) Pub. No.: US 2025/0104952 A1
(43) Pub. Date: Mar. 27, 2025

(54) ARC EXTINGUISHING UNIT OF MOLDED CASE CIRCUIT BREAKER

(71) Applicant: LS ELECTRIC CO., LTD., Anyang-si, Gyeonggi-do (KR)

(72) Inventors: Younghwan KIM, Anyang-si, Gyeonggi-do (KR); Kihwan OH, Anyang-si, Gyeonggi-do (KR); Insu SEO, Anyang-si, Gyeonggi-do (KR); Kyunghwan OH, Anyang-si, Gyeonggi-do (KR); Jihyoung KIM, Anyang-si, Gyeonggi-do (KR); Jaesung LEE, Anyang-si, Gyeonggi-do (KR)

(21) Appl. No.: 18/727,790

(22) PCT Filed: Jan. 2, 2023
(86) PCT No.: PCT/KR2023/000036

§ 371 Date: Jul. 10, 2024

(30) Foreign Application Priority Data
Jan. 13, 2022 (KR) 10-2022-0005428
Jan. 13, 2022 (KR) 10-2022-0005429

(51) Int. Cl. H01H 73/18

(52) U.S. Cl. CPC H01H 73/18

(57) ABSTRACT

The present disclosure relates to an arc extinguishing unit of a molded case circuit breaker and, more specifically to an arc extinguishing unit of a molded case circuit breaker, having improved arc elongation performance. The arc extinguishing unit of a molded case circuit breaker, according to one embodiment of the present disclosure, comprises: a first side plate and a second side plate arranged to be spaced a predetermined distance apart from each other; a plurality of grids arranged by predetermined intervals between the first side plate and the second side plate; and an insulation member arranged to adjoin each of the plurality of grids.

### TECHNICAL FIELD

The present disclosure relates to an arc extinguishing unit of a molded case circuit breaker, and more specifically, to an arc extinguishing unit of a molded case circuit breaker with improved arc extension performance.

### BACKGROUND ART

In general, a molded case circuit breaker (MCCB) is an electric device that automatically shuts off a circuit during an overload condition or a short-circuit accident to protect the circuit and load.

The molded case circuit breaker includes a terminal unit capable of being connected to a power source side or a load side, a contact unit including a stationary contactor and a movable contactor brought into contact with or separated from the stationary contactor to connect or disconnect a circuit, a switching mechanism that moves the movable contactor to provide power required for the switching of the circuit, a trip unit that senses an overcurrent or a short-circuit current flowing on the circuit to induce a trip operation of the switching mechanism, and an arc extinguishing unit for extinguishing an arc generated when an abnormal current is interrupted, and the like.

FIG. 1 shows an internal structural view of a molded case circuit breaker according to the related art. A molded case circuit breaker according to the related art includes a stationary contactor 1 and a movable contactor 2 constituting a contact unit provided to connect or disconnect a circuit transmitted from a power source side to a load side within a case 9 formed of an insulating material, a switching mechanism unit 4 that provides power capable of rotating the movable contactor 2, an arc extinguishing unit 3 provided to extinguish an arc generated when a fault current is interrupted, and a trip unit 5 that detects an abnormal current to trip the switching mechanism, and the like. Here, reference numeral 8 denotes a case (also referred to as a base) of a base assembly.

When a fault current flows in the circuit, a trip operation is carried out by the operation of the trip unit 5 and the switching mechanism unit 4 to separate the movable contactor 2 from the stationary contactor 1 so as to interrupt the flow of current, and at this time, an arc is generated at a contact unit 1, 2. At this time, the magnitude (intensity) of the arc is proportional to the magnitude of the current. An arc is a discharge in which gas in the air instantaneously reaches a plasma state by a voltage, and the arc center temperature reaches 8,000 to 12,000° C. and has an explosive expansion pressure. As a result, it has characteristics in that the contact unit 1, 2 are melted and consumed, and neighboring parts are deteriorated and destroyed, and thus the continuity or non-continuity of the arc greatly affects the performance and durability of the circuit breaker. Therefore, the arc must be quickly interrupted, extinguished and discharged from the arc extinguishing unit 3.

In this manner, in a molded case circuit breaker, an operation of processing an arc is a main purpose in interrupting a fault current to protect a product, a load and a line and directly affects the performance of the circuit breaker.

FIGS. 2 and 3 show a base assembly in a molded case circuit breaker according to the related art. The base assembly includes a base assembly case 8 formed by injection molding with an insulating material, and the contact unit 1, 2 and the arc extinguishing unit 3 provided on the base assembly case 8. FIG. 2 shows a conduction state, and FIG. 3 shows an interruption state.

The movable contactor 2 is coupled to a shaft 6 to rotate. The movable contactor 2 is coupled to the shaft 6 rotated by receiving a force of the switching mechanism unit 4 to rotate, and a contact unit at which a stationary contact of the stationary contactor 1 and a movable contact of the movable contactor 2 are brought into contact with each other is disposed inside a side plate 3a of the arc extinguishing unit 3.

The operation of the base assembly when a fault current is interrupted is as follows.

When the fault current occurs, the switching mechanism unit 4 is actuated by the action of the trip unit 5, and accordingly, the shaft 6 rotates in a clockwise direction. At this time, an arc is generated at the contact unit 1, 2, and the arc is dividedly cooled while moving to a grid 3b in the arc extinguishing unit (arc chamber) 3. As the arc moves along the grid 3b, an arc voltage increases and the arc eventually disappears.

In a mold case circuit breaker, the success of interruption depends on rapid arc extinguishment. That is, the rotation speed of the shaft 6 must be fast, and the generated arc must quickly spread to the grid 3b to increase an arc voltage.

FIG. 4 shows an arc extinguishing unit of a molded case circuit breaker according to the related art, and FIG. 5 is a partial cross-sectional view taken along portion A-A in FIG. 4.

The arc extinguishing unit 3 includes side plates 3a and grids 3b. The side plates 3a are provided as a pair disposed in parallel, and the grids 3b are provided in multiple pieces coupled between the two side plates 3a.

However, an arc extinguishing unit of a molded case circuit breaker in the related art does not secure a sufficient distance d between the grids 3b due to a limited space, so arc extension for arc extinguishment is not properly carried out.

Referring to FIG. 6, the upper drawing shows an arc A entering the grids 3b at the beginning of interruption (t=t1). There is shown a state in which the arc A enters adjacent grids 3b while being divided into intervals between the grids 3b. Afterwards, the arc A is pushed to the rear of the grids 3b by pressure, and in the lower drawing, the arc A maintains a length corresponding to a spacing between the grids 3b in the state of reaching the rear of the grids 3b in the middle of interruption (t=t2) after a predetermined time has elapsed. That is, it is shown that arc extension is not carried out well.

Meanwhile, referring to FIG. 7, the arc A enters between the grids 3b at the beginning of interruption (t=t1), and after a predetermined time has elapsed (t=5), the arc A exits the grids 3b to head toward the vent. The arc A becomes thinner, releases heat, and eventually disappears as it flows while being divided into the grids 3b, but as shown in the drawing, if extension is not carried out well, it may not disappear completely to remain so as to be recurred at the rear of the grids 3b.

### DISCLOSURE OF INVENTION

### Technical Problem

The present disclosure is contrived to solve the foregoing problems, and an aspect of the present disclosure is to provide an arc extinguishing unit of a molded case circuit breaker with improved interruption performance due to an increase in arc extension during interruption.

### Solution to Problem

An arc extinguishing unit of a molded case circuit breaker according to an embodiment of the present disclosure may include a first side plate and a second side plate disposed to be spaced apart from each other by a predetermined distance; a plurality of grids disposed at predetermined intervals between the first and second side plates; and insulating members disposed in surface contact with the plurality of grids, respectively.

Here, the grids and the insulating members may be alternately disposed with one another.

Furthermore, the insulating member may be formed in the same shape as that of the grid.

Furthermore, a thickness of the insulating member may be formed to be thinner than that of the grid.

Furthermore, a lowermost insulating member among the plurality of grids and insulating members may be disposed in surface contact with a lower surface of a lowermost grid, and the remaining insulating members among the plurality of grids and insulating members may be disposed in surface contact with upper surfaces of the remaining grids.

Furthermore, insertion grooves into which the grid and the insulating member may be inserted together are disposed in the first and second side plates.

In addition, an entry portion adjacent to a contact unit in the grid may extend from an insulator entry portion adjacent to the contact unit in the insulating member.

An arc extinguishing unit of a molded case circuit breaker according to another aspect of the present disclosure may include a first side plate and a second side plate disposed to be spaced apart from each other by a predetermined distance; and a plurality of grid-insulator combinations disposed at predetermined intervals between the first and second side plates, wherein the grid-insulator combinations include a plurality of grids disposed at predetermined intervals between the first and second side plates; and insulating members coupled in surface contact with upper or lower surfaces of the plurality of grids, respectively.

An arc extinguishing unit of a molded case circuit breaker according to another embodiment of the present disclosure may include a first side plate and a second side plate disposed to be spaced apart from each other by a predetermined distance; a plurality of grids disposed between the first and second side plates; first insulating members disposed in surface contact with first surfaces of the plurality of grids, respectively; and second insulating members disposed in surface contact with second surfaces of the plurality of grids, respectively.

Here, the first insulating member and the second insulating member may be formed in the same shape as that of the grid.

Furthermore, the first insulating member and the second insulating member may be disposed to have a thickness smaller than that of the grid.

Furthermore, the first insulating member and the second insulating member may be disposed in parallel to the grid.

Furthermore, insertion grooves into which the grid, the first insulating member, and the second insulating member are inserted together may be disposed in the first and the second side plates.

Furthermore, an entry portion or cutout portion facing a contact unit in the grid may extend (protrude) from a first insulator entry portion or first insulator cutout portion of the first insulating member and a second insulator entry portion or second insulator cutout portion of the second insulating member.

In addition, a first insulator rear portion of the first insulating member and a second insulator rear portion of the second insulating member may extend (protrude) from a rear portion of the grid.

An arc extinguishing unit of a molded case circuit breaker according to another aspect of the present disclosure may include a first side plate and a second side plate disposed to be spaced apart from each other by a predetermined distance; and a plurality of grid-insulator combinations disposed at predetermined intervals between the first and second side plates, wherein the grid-insulator combinations include a plurality of grids disposed at predetermined intervals between the first and second side plates; a plurality of first insulating members coupled in surface contact with first surfaces of the plurality of grids, respectively; and a plurality of second insulating members coupled in surface contact with first surfaces of the plurality of grids, respectively.

### Advantageous Effects of Invention

According to an arc extinguishing unit of a molded case circuit breaker according to an embodiment of the present disclosure, there is provided a grid-insulator combination in which an insulating member is coupled to one surface of a grid, and during interruption, for an arc divided between grid-insulator combinations 270, 280, an arc portion on a side surface of the grid advances to the rear of the arc extinguishing unit, but an arc portion on a side of the insulating member cannot advance to the rear of the arc extinguishing unit, and as a result, the extension effect of the divided arc increases.

Therefore, the heat capacity of the grid may be reduced to decrease a thickness of the grid.

According to an arc extinguishing unit of a molded case circuit breaker according to another embodiment of the present disclosure, insulating members are provided on both sides of the grid, and as a result, both ends of an arc remain at an entry portion of the grid by the insulating members, and only a middle portion of the arc advances to the rear of the grid, and thus the arc extends well. Therefore, arc extinction is carried out efficiently.

Accordingly, a likelihood of arc recurrence is reduced.

Meanwhile, the heat capacity of the grid may be reduced to decrease a thickness of the grid.

### BRIEF DESCRIPTION OF DRAWINGS

FIG. 1 is an internal structural view showing a molded case circuit breaker according to the related art.

FIGS. 2 and 3 are perspective views of a base assembly in a molded case circuit breaker according to the related art. FIG. 2 shows an on state, and FIG. 3 shows an off state.

FIG. 4 is a perspective view of an arc extinguishing unit of a molded case circuit breaker according to the related art.

FIG. 5 is a partial cross-sectional view of a portion B-B in FIG. 4.

FIG. 6 is a perspective view cut along portion B-B in FIG. 4.

FIG. 7 is a perspective view taken along portion B-B in FIG. 4, viewed from a different angle.

FIG. 8 is an internal structural view showing a molded case circuit breaker according to an embodiment of the present disclosure.

FIGS. 9 and 10 are perspective views showing a base assembly in a molded case circuit breaker according to an embodiment of the present disclosure. FIG. 9 shows an on state, and FIG. 10 shows an off state.

FIGS. 11 and 12, respectively, show perspective views of an arc extinguishing unit of a molded case circuit breaker according to an embodiment of the present disclosure. FIG. 11 shows a state in which a grid and a side plate are coupled to each other, and FIG. 12 shows a state in which one side plate is separated from the grid.

FIG. 13 is a partial cross-sectional view taken along portion C-C in FIG. 11.

FIG. 14 is a perspective view cut along portion C-C in FIG. 11.

FIG. 15 shows a process during an arc interruption in FIG. 14.

FIG. 16 is a front view of a grid according to another embodiment of the present disclosure.

FIG. 17 is an internal structural view illustrating a molded case circuit breaker according to another embodiment of the present disclosure.

FIGS. 18 and 19 are perspective views showing a base assembly in a molded case circuit breaker according to another embodiment of the present disclosure. FIG. 18 shows an on state, and FIG. 19 shows an off state.

FIGS. 20 and 21 are perspective views, respectively, showing an arc extinguishing unit of a molded case circuit breaker according to an embodiment of the present disclosure, viewed from different directions.

FIG. 22 shows a state in which one side plate is separated from the grid in an arc extinguishing unit of a molded case circuit breaker according to an embodiment of the present disclosure.

FIG. 23 is a perspective view of a grid-insulator combination in FIG. 22.

FIG. 24 shows a process during an arc interruption in an arc extinguishing unit of a molded case circuit breaker according to another embodiment of the present disclosure. Here, (a) is a cut-away perspective view, and (b) is a cut-away cross-sectional view.

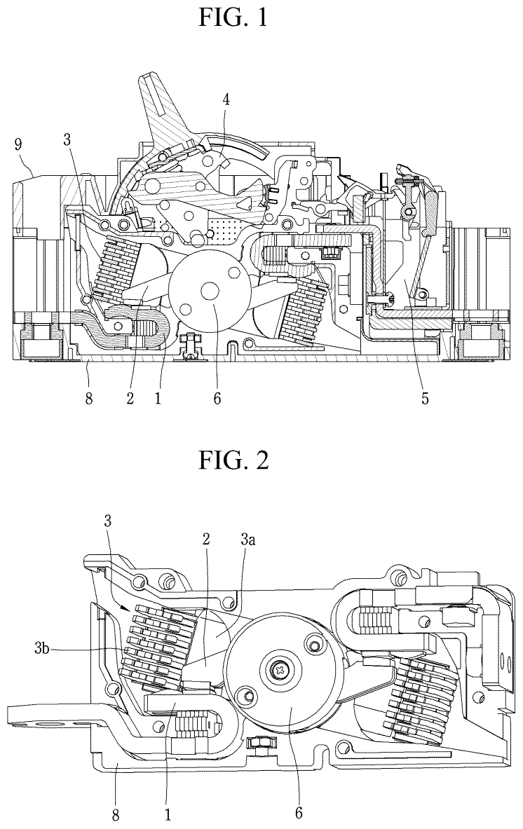

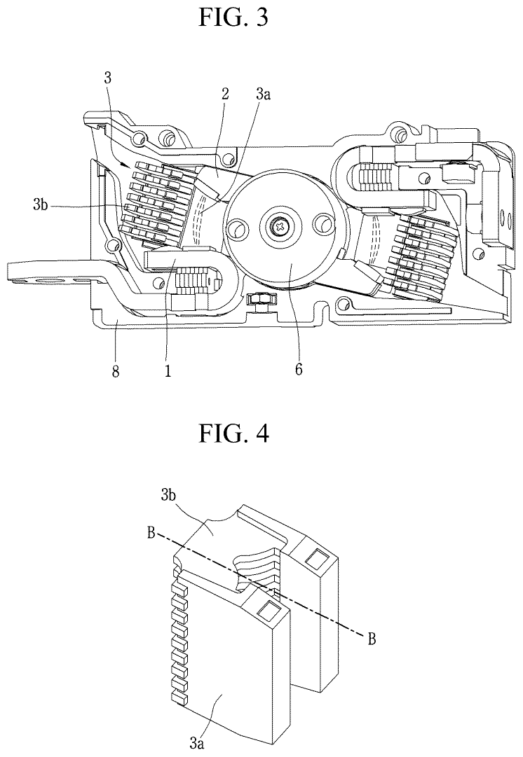

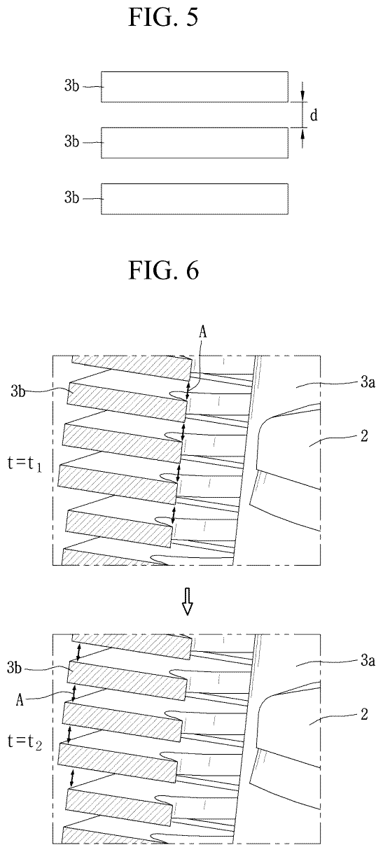

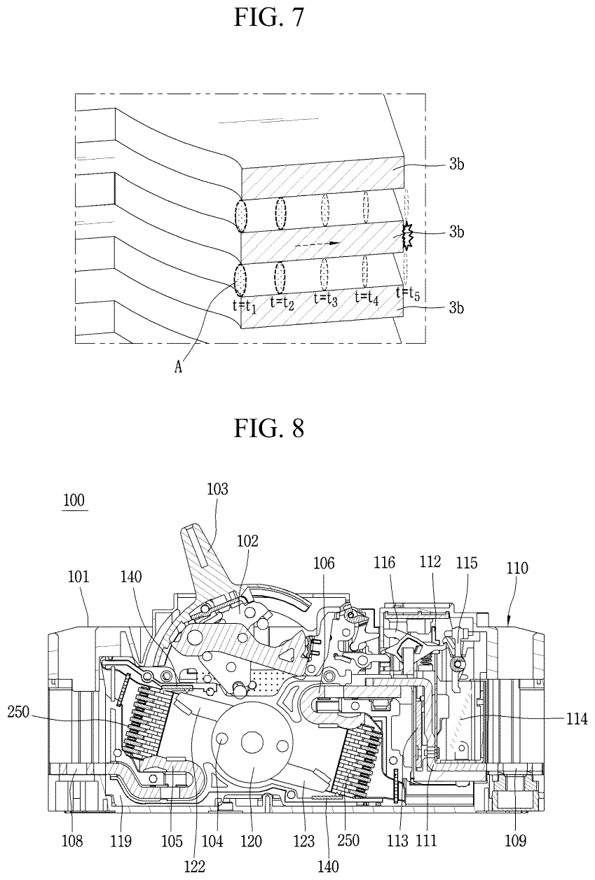

### MODE FOR THE INVENTION

Hereinafter, preferred embodiments of the present disclosure will be described with reference to the accompanying drawings, which are intended to describe the present disclosure in detail to allow a person skilled in the art to easily carry out the invention, but not to mean that the technical concept and scope of the present disclosure are limited thereto.

An arc extinguishing unit of a molded case circuit breaker according to each embodiment of the present disclosure will be described in detail with reference to the drawings.

An arc extinguishing unit 250 of a molded case circuit breaker 100 according to an embodiment of the present disclosure includes a first side plate 251 and a second side plate 252 disposed to be spaced apart from each other by a predetermined distance; a plurality of grids 270 disposed at predetermined intervals between the first and second side plates 251, 252; and a plurality of insulating members 280 disposed in surface contact with the grids 270, respectively.

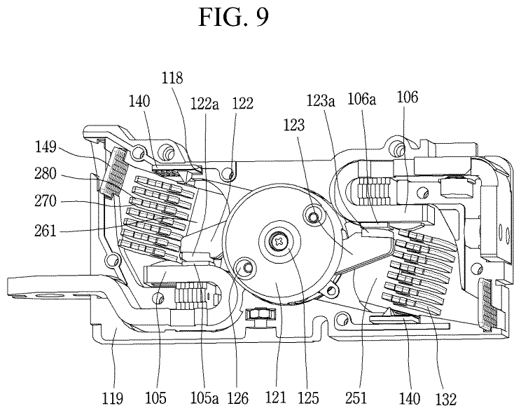

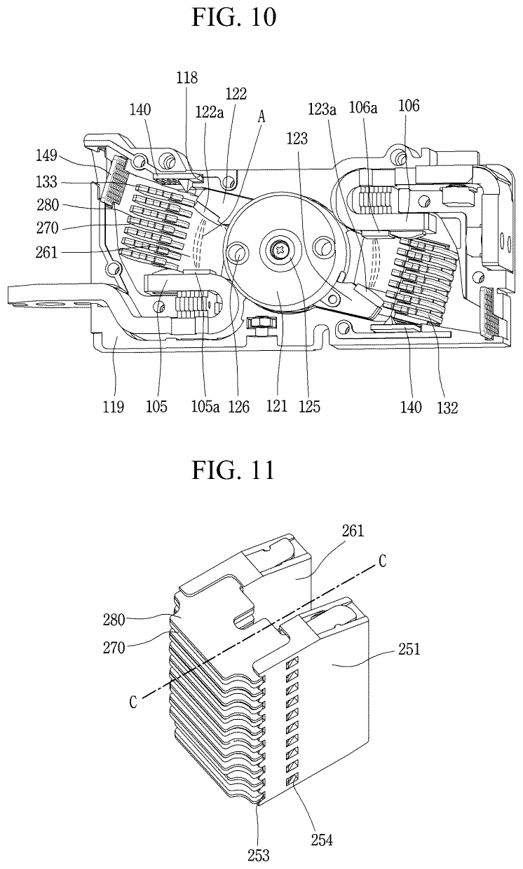

FIG. 8 is an internal structural view showing a molded case circuit breaker according to an embodiment of the present disclosure, and FIGS. 9 and 10 are perspective views showing a base assembly in a molded case circuit breaker according to an embodiment of the present disclosure. FIG. 9 shows an on state, and FIG. 10 shows an off state.

A molded case circuit breaker according to an embodiment of the present disclosure includes stationary contactors 105, 106 fixedly provided in part of a base assembly case 119, movable contactors 122, 123 brought into contact with or separated from the stationary contactors 105, 106, and an arc extinguishing unit 250 that extinguishes an arc generated when the movable contactors 122, 123 are separated from the stationary contactors 105, 106.

Here, the arc extinguishing unit 250 includes a pair of side plates 251, 261, and a plurality of grid-insulator combinations 270, 280 provided at predetermined intervals between the pair of side plates 251, 261.

A case 101 accommodates and supports the components of the molded case circuit breaker. The case 101 is formed in a substantially box shape. A handle 103 is exposed on an upper surface of the case 101. The handle 103 operates a switching mechanism 102 by a user's manual operation force.

Terminal portions 108, 109 capable of being connected to a power source or a load are provided on front and rear surfaces of the case 101. The terminal portions 108, 109 are provided for each phase (or for each pole). For example, in the case of a three-phase four-pole molded case circuit breaker, four terminal portions may be provided on the power source side and the load side, respectively.

Stationary contactors 105, 106 are fixedly provided inside the case 101. The stationary contactors 105, 106 are connected to the terminal portions 108, 109, respectively. In the case of a double molded case circuit breaker, the stationary contactors 105, 106 are provided on a power source side and a load side thereof, respectively. In other words, a power source side stationary contactor 105 and a load side stationary contactor 106 are provided. At this time, the power source side stationary contactor 105 may be directly connected to or integrally formed with the power source side terminal portion 108. The load side stationary contactor 106 may be connected to the load side terminal portion 109 through a trip mechanism (particularly, a heater 111).

In the vicinity of the contact unit (stationary contactor and movable contactor), an arc extinguishing unit (arc extinguishing device, arc chamber, arc chute) 250 is provided to extinguish an arc generated during interruption. In the case of a double molded case circuit breaker (double circuit breaker), the arc extinguishing units 250 are provided on a power source side and a load side thereof, respectively. The arc extinguishing unit 250 includes a pair of side plates 251, 261 and a plurality of grids 270 coupled to the side plates 251, 261 at predetermined intervals.

A trip unit 110 that detects an abnormal current flowing through a circuit and tripping the switching mechanism is provided in a part of the case 101. The trip portion 110 is usually provided on the load side. The trip unit 110 may include a heater 111 connected to the load side terminal unit 109, a bimetal 112 coupled to the heater 111 to sense heat so as to be bent according to the amount of heat, a magnet and an amateur 114 provided around the heater 111, a crossbar 115 provided to rotate by the contact of the bimetal 112 and the armature 113, and a shooter 116 restrained or released by the rotation of the crossbar 115 to restrain or release a nail (not shown) of the switching mechanism 102. Typically, the bimetal 112 is bent by heat generated from the heater 111 to rotate the crossbar 115 so as to operate the switching mechanism 102 during small current delay interruption, and the crossbar 115 rotates while the armature 114 is attracted by a magnetic force excited in the magnet 113 to operate the switching mechanism 102 during a large current during large current instant interruption.

The user's operation force is transferred to the switching mechanism 102 through the handle 103. A pair of rotation pins 104 are provided on the switching mechanism 102 to transfer the power of the switching mechanism 102 to each phase. The rotation pin 104 is formed to have a length across all phases and provided in the shaft assembly (or mover assembly) 120.

A base assembly case (briefly, base) 119 is provided. The base assembly case 119 may be formed by injection molding. The base assembly case 119 is formed approximately in the form of a box. The base assembly case 119 is provided with contact portions 105, 106, 122, 123 and an arc extinguishing unit 250. The switching mechanism 102 may be provided at a top of the base assembly case 119.

The shaft assembly 120 is provided. The shaft assembly 120 is provided with a rotation pin 104 passing therethrough. The shaft assembly 120 receives the switching power of the switching mechanism 102 by the rotation pin 104 to rotate. As the shaft assembly 120 rotates, the movable contactor 122, 123 also rotates to be brought into contact with or separated from the stationary contactors 105, 106.

The shaft assembly 120 includes a shaft body 121 and movable contacts 122, 123.

The shaft body 121 is formed in a cylindrical shape. A shaft 125 is disposed to protrude from both flat side surfaces (disk surfaces) of the shaft body 121. A pair of pinholes 126 through which the rotation pin 104 can be inserted are formed in the shaft body 121 in parallel to a direction of the shaft 125.

The movable contactors 122, 123 are rotatably provided on the shaft body 121. The movable contactor 122, 123 is brought into contact with or separated from the stationary contactors 105, 106 while rotating with the shaft body 121 or independently in a counterclockwise or clockwise direction to conduct or cut off the line.

Movable contacts 122a, 123a that can be brought into contact with the stationary contacts 105a, 106a of the stationary contactors 105, 106, respectively, are provided at both ends of the movable contactors 122, 123. The movable contacts 122a, 123a may be made of a material with excellent electrical conductivity and durability, such as a silver (Ag) alloy.

The movable contactor 122, 123 rotates together with the shaft body 121 in the case of a general small current or large current interruption situation, but the movable contactor 122, 123 rotates independently by a sudden electromagnetic repulsion force during cold current interruption. In this case, the movable contactor 122, 123 comes into contact with the shaft pin (not shown) of the shaft body 121 to stop the rotation.

Stationary contacts 105a, 106a are provided at both ends of the stationary contactors 105, 106, respectively. The stationary contacts 105a, 106a may be made of a material with excellent electrical conductivity and durability, such as a silver (Ag) alloy.

The arc extinguishing unit 250 is provided around the stationary contacts 105a, 106a of the stationary contactors 105, 106 and the movable contacts 122a, 123a of the movable contactors 122, 123.

When the circuit is in a normal state, the stationary contacts 105a, 106a of the stationary contactors 105, 106 are connected to the movable contacts 122a, 123a of the movable contactors 122, 123 to allow current to flow. When an accident current occurs in the circuit, the movable contactors 122, 123 are rotated by the mechanism unit (not shown) to separate the movable contacts 122a, 123a from the stationary contacts 105a, 106a so as to cut off the current. At this time, an arc is generated between the movable contacts 122a, 123a and the stationary contacts 105a, 106a. The arc is divided into short arcs while entering between the grids 270 to increase an arc voltage. In addition, the arc voltage is further increased by an arc extinguishing gas, such as SF6, existing in the arc extinguishing unit. As a result, the arc is annihilated while suppressing the emission of free electrons.

The arc extinguishing unit 250 will be described. FIGS. 10 and 11, respectively, show perspective views of an arc extinguishing unit of a molded case circuit breaker according to an embodiment of the present disclosure. FIG. 10 shows a state in which a grid and a side plate are coupled to each other, and FIG. 11 shows a state in which one side plate is separated from the grid.

The arc extinguishing unit (arc shooter) 250 includes a side plate 251, 261 that forms a pair of side walls facing symmetrically and a grid 270 formed with a plurality of steel sheets to be inserted in parallel into the side plate 251, 261 at predetermined intervals. The arc extinguishing unit 250 is surrounded by the side plate 251, 261 and the grid 270 to form an internal space capable of extinguishing an arc.

A pair of symmetrical side plates 251, 261 are provided. The side plates 251, 261 are preferably made of an insulating material. That is, an arc generated at the time of interruption may be reflected by the side plates 251, 261 and collected by the grid 270.

A plurality of fitting grooves 253, 263 and fitting holes 254, 264 to which the grid-insulator combinations 270, 280 can be coupled are disposed in the side plates 251, 261.

The side plates 251, 261 are provided with coupling portions 255, 265 into which a leg portion 276 of the grid 270 and an insulator leg portion 286 of the insulating member 280 are inserted.

The side plates 251, 261 are disposed to protrude from a plurality of support plates 252, 262, and the grid-insulator combinations 270, 280 are inserted into the insertion grooves 256, 266 disposed between respective support plates 252, 262 and support plates 252, 262 adjacent thereto.

Grid-insulator combinations 270, 280 are provided. Here, the grid-insulator combinations 270, 280 include grids 270 and insulating members 280.

The grids 270 are provided to attract and extinguish the arc. At this time, a plurality of grids 270 are provided at predetermined intervals on the pair of side plates 251, 261.

The grid 270 is formed as a flat plate. The grid 270 is preferably made of steel so as to attract the arc. A plurality of fitting protrusions 273, 274 are disposed to protrude from both side surfaces of grid 270 so as to be provided on the side plate 251, 261. The fitting protrusions 273, 274 of the grid 270 are fitted into the fitting grooves 253, 263 and the fitting holes 254, 264 of the side plates 251, 261. At this time, a caulking operation may be carried out for stable coupling.

A front portion (a right portion in the drawing) of the grid 270 has an entry portion 272 into which a contact unit is inserted and an arc is sucked. The entry portion 272 is a surface where the arc A is attracted and initially brought into contact with the grid 270.

In the grid 270, a central portion of the entry portion 272 is cut to form a cutout portion 275. The cutout portion 275 provides a space in which the contact unit can be operated to divide the arc. The cutout portion 275 may be formed by a V-shaped groove, a U-shaped groove, or the like. Accordingly, arc division performance may be improved.

A description thereof will be given with further reference to FIG. 13. FIG. 13 is a partial cross-sectional view taken along portion C-C in FIG. 10. A plurality of grid-insulator combinations 270, 280 may be provided and installed at predetermined intervals h in multiple layers on the side plates 251, 261. Accordingly, a passage through which the arc can pass is provided between the grid-insulator combinations 270, 280 and the grid-insulator combinations 270, 280. A spacing when the grid-insulator combinations 270, 280 are stacked may be set appropriately in consideration of the division and attraction force of an arc.

An adsorption grid 140 is provided to improve the attraction performance of the arc and absorb dust. The adsorption grid 140 is provided at a top of the base assembly case 119. A fixing groove 118 is disposed at the top of the base assembly case 119 into which the absorption grid 140 is fitted.

An exhaust plate 149 is provided. The exhaust plate 149 is provided behind the grid 270 to discharge arc gas and prevent foreign substances from intruding. A plurality of ventilation holes 251 are disposed in the exhaust plate 149.

The grid will be further described in more detail.

The grid 270 is formed as a flat plate. The grid 270 is made of a material with excellent electrical conductivity, such as aluminum (Al).

The grid 270 includes a central plate portion 271 and a leg portion 276. The central plate portion 271 is a surface where an arc is divided and cooled while being attracted and entered.

A plurality fitting protrusions 273, 274 are spaced apart from one other and disposed to protrude from both side surfaces of the central plate portion 271 so as to be provided on the side plates 251, 261. The fitting protrusions 273, 274 of the grid 270 are fitted into the fitting grooves 253, 263 and the fitting holes 254, 264 of the side plates 251, 261. At this time, a caulking operation may be carried out for stable coupling.

An entry portion 272 into which a contact unit is inserted and an arc is sucked is disposed at a front portion of the central plate portion 271. The entry portion 272 is a surface where the arc A is attracted and initially brought into contact with the grid 270.

A central portion of the entry portion 272 of the central plate portion 271 is cut to form a cutout portion 275. The cutout portion 275 provides a space in which the contact unit can be operated to divide the arc. The cutout portion 275 may be formed by a V-shaped groove, a U-shaped groove, or the like. Accordingly, arc division performance may be improved.

The leg portions 276 are disposed to protrude from both sides of the entry portion 272 of the central plate portion 271, respectively. The leg portion 276 is inserted into and coupled to the cap portions 255, 265 of the side plates 251, 261. Since the leg portion 276 is fixed to the coupling portions 255, 265 of the side plates 251, 261, the grid 270 remains stably coupled to the side plates 251, 261.

An insulating member 280 is provided. The insulating member 280 may be formed in the same or similar shape as that of the grid 270. The insulating member 280 may be formed in the same shape as that of the grid 270 when viewed from the top.

The insulating member 280 is disposed to have a thickness smaller than that of the grid 270. Accordingly, the grid 270 and the insulating member 280 may be inserted together into the insertion grooves 256, 266 of the conventionally used side plates 251, 261 without changing the side plates 251, 261.

The insulating member 280 is formed as a flat plate. The insulating member 280 is made of a material with excellent insulating properties.

The insulating member 280 includes an insulator central plate portion 281 and an insulator leg portion 286. The insulator central plate portion 281 is a surface where an arc is divided and cooled while being attracted and entered.

A plurality of insulator fitting protrusions 283, 284 are spaced apart from one another to protrude from both side surfaces of the insulator central plate portion 281 so as to be provided on the side plates 251, 261. The insulator fitting protrusions 283, 284 of the insulating member 280 are fitted into the fitting grooves 253, 263 and the fitting holes 254, 264 of the side plates 251, 261. At this time, a caulking operation may be carried out for stable coupling.

An insulator entry portion 282 into which a contact unit is inserted and an arc is sucked is disposed at a front portion of the insulator central plate portion 281. The insulator entry portion 282 is a surface where the arc A is attracted and initially brought into contact with the insulating member 280.

A central portion of the insulator entry portion 282 of the insulator central plate portion 281 is cut to form an insulator cutout portion 285. The insulator cutout portion 285 provides a space in which the contact unit can be operated to divide the arc. The insulator cutout portion 285 may be formed by a V-shaped groove, a U-shaped groove, or the like. Accordingly, arc division performance may be improved.

The insulator leg portions 286 are disposed to protrude from both sides of the insulator entry portion 282 of the insulator central plate portion 281, respectively. The insulator leg portion 286 is inserted into and coupled to the cap portions 355, 265 of the side plates 351, 261. Since the insulator leg portion 286 is fixed to the cap portions 255, 265 of the side plates 251, 261, the insulating member 280 remains stably coupled to the side plates 251, 261.

The insulating member 280 is disposed to have a thickness smaller than that of the grid 270.

A plurality of grid-insulator combinations 270, 280 have the same arrangement order of the grid 270 and the insulating member 280, except for a lowermost grid-insulator combination 270-1, 280-1. That is, in the grid-insulator combination 270, 280, the grid 270 is disposed below and the insulating member 280 is disposed above. In other words, the insulating member 280 is disposed in surface contact with an upper surface of the grid 270.

Among the grid-insulator combinations 270, 280, in the lowermost grid-insulator combination 270, 280, a lowermost grid 270-1 is disposed above and a lowermost insulating member 280-1 is disposed below. In other words, the lowermost insulating member 280-1 is disposed on a lower surface of the lowermost grid 270-1.

The lowermost grid 270-1 and a second grid 270 are in surface contact with each other, and thus arc attraction performance is superior to that of another grid 270. That is, a grid adjacent to the contact unit ensures the arc attraction performance not to be reduced.

Meanwhile, the insulating member 280 is disposed at a bottom of the lowermost grid-insulator combination 270, 280 so as to prevent insulation breakdown to the contact unit.

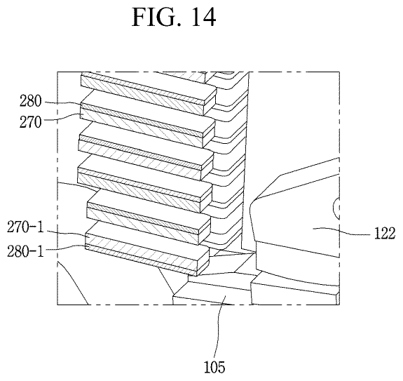

FIG. 14 shows a perspective view cut along plane C-C in FIG. 11. There is shown a conduction state in which the contact unit is in contact. In the lowermost grid-insulator combination 270, 280 adjacent to the contact unit, there is shown a state in which the lowermost insulating member 280-1 is coupled to a bottom of the lowermost grid 270-1. In the remaining grid-insulator combinations 270, 280, the insulating member 280 is coupled to a top of the grid 270.

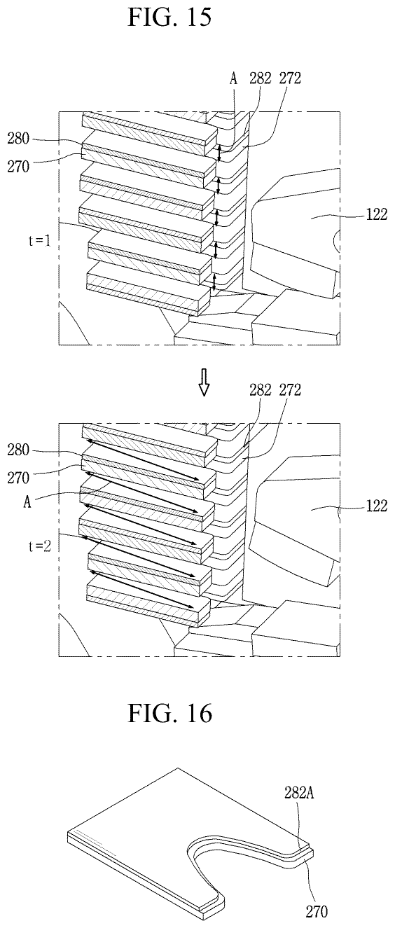

FIG. 15 shows an advancing state of the arc A during interruption.

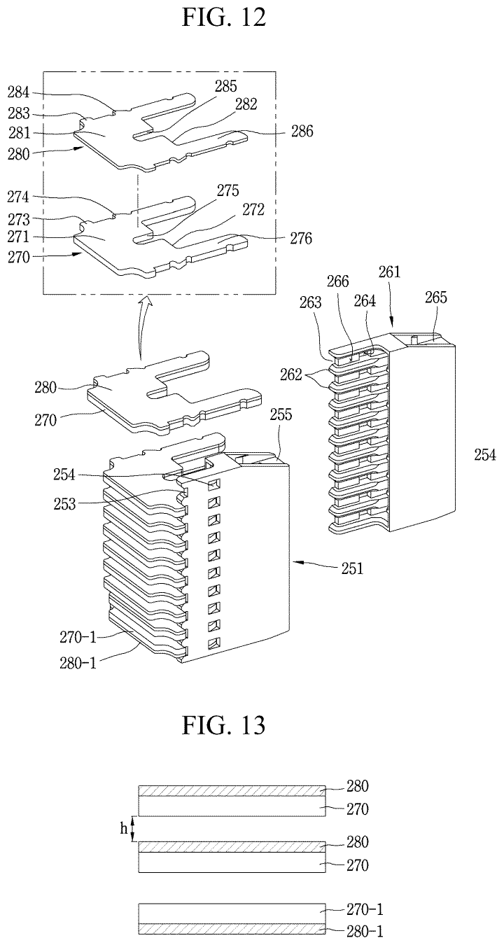

Referring to a drawing shown at an upper portion of FIG. 15, at the beginning of interruption (t=t1), the arc A is attracted through the entry portion 272, 282 of the grid-insulator combination 270, 280. The arc A is divided into intervals between the grid-insulator combinations 270, 280. At this time, the arc A is divided into a size of h, which is a spacing between the grid-insulator combinations 270, 280 as shown in FIG. 12. Here, referring to any one divided arc A, it can be seen that one end thereof is in contact with the entry portion 272 of the grid 270 and the other end thereof is in contact with the insulator entry portion 282.

Referring to a drawing shown at a lower portion of FIG. 15, in the middle of interruption (t=t2), the arc A exits to the rear (a left portion in the drawing) of the grid-insulator combination 270, 280. At this time, a portion of the arc A (i.e., an upper end of the arc) attracted into the entry portion 272 of the grid 270 advances rearward along a surface of the grid 270, while a portion of the arc A (i.e., a lower end of the arc) attracted into the insulator entry portion 282 of the insulating member 280 remains as it is. Therefore, each divided arc A is effectively extended to improve interruption performance.

According to an arc extinguishing unit of a molded case circuit breaker according to an embodiment of the present disclosure, there is provided a grid-insulator combination in which an insulating member is coupled to one surface of a grid, and during interruption, for an arc divided between the grid-insulator combinations 270, 280, an arc portion on a side surface of the grid advances to the rear of the arc extinguishing unit, but an arc portion on a side of the insulating member cannot advance to the rear of the arc extinguishing unit, and as a result, the extension effect of the divided arc increases.

Therefore, the heat capacity of the grid may be reduced to decrease a thickness of the grid.

FIG. 16 is a perspective view of a grid-insulator combination 270, 280A according to another embodiment.

Here, a description of a portion that is the same as the grid-insulator combination 270, 280 in the previous embodiment will be omitted, and the other portion thereof will be described.

In the grid-insulator combination 270, 280A of this embodiment, a length of the grid 270 is disposed to be larger than that of the insulating member 280A. In other words, a length of the insulating member 280A is disposed to be shorter than that of the grid 270.

Accordingly, the entry portion 272 of the grid 270 protrudes compared to the insulator entry portion 282A. Therefore, the attraction of the arc is maximized without reducing the arc attraction effect at the beginning of interruption, and at the same time, the arc extension effect is increased in the middle of interruption.

An arc extinguishing unit 350 of a molded case circuit breaker according to another embodiment of the present disclosure includes a first side plate 351 and a second side plate 361 disposed to be spaced apart from each other by a predetermined distance, a plurality of grids 370 disposed between the first side plate 351 and the second side plate 361, a plurality of first insulating members 380 disposed in surface contact with first surfaces (upper surfaces) of the plurality of grids 370, and a plurality of second insulating members 390 disposed in surface contact with second surfaces (lower surfaces) of the plurality of grids 370.

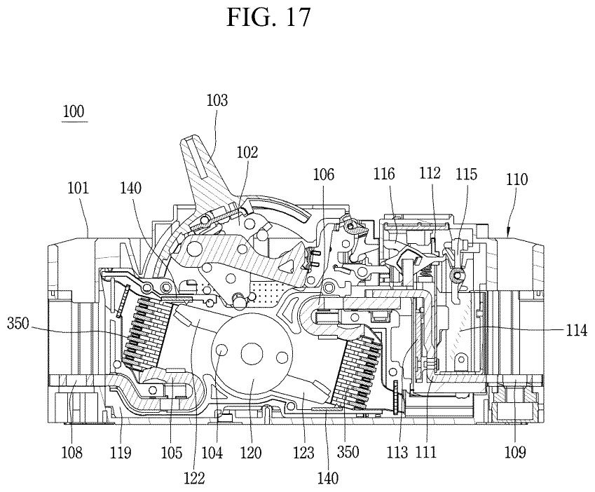

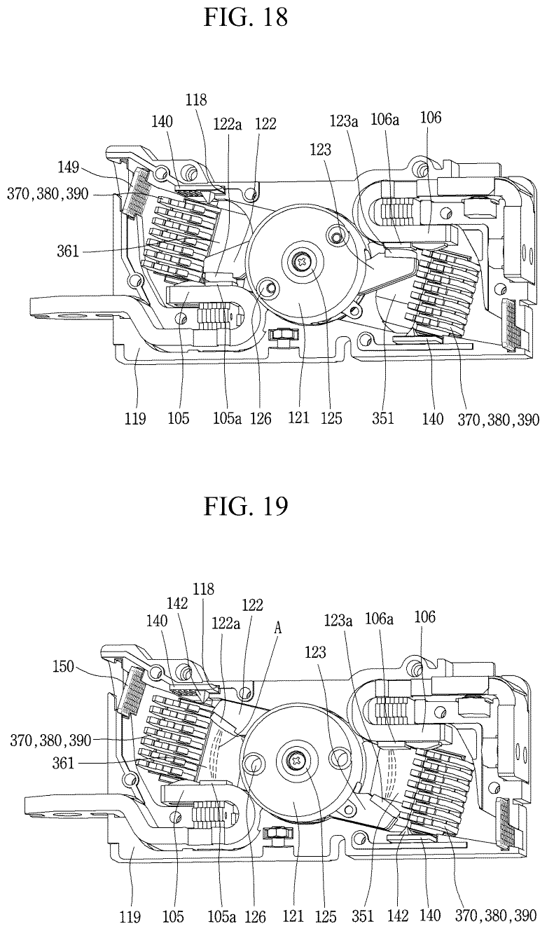

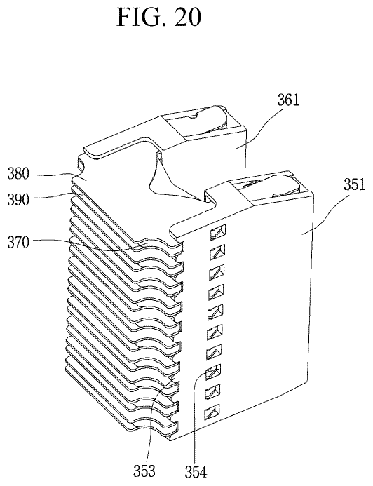

FIG. 17 is an internal structural view illustrating a molded case circuit breaker according to an aspect of the present disclosure, and FIGS. 18 and 19 are internal structural views of a base assembly in FIG. 17, There are shown a conduction state (closed state) and an interruption state (open state), respectively.

A molded case circuit breaker 100 according to an embodiment of the present disclosure includes stationary contactors 105, 106 fixedly provided in part of a base assembly case 119, movable contactors 122, 123 brought into contact with or separated from the stationary contactors 105, 106, and an arc extinguishing unit 350 that extinguishes an arc generated when the movable contactors 122, 123 are separated from the stationary contactors 105, 106.

Here, the arc extinguishing unit 350 includes a pair of side plates 351, 361, and a plurality of grids 370 provided at predetermined intervals between the pair of side plates 351, 361.

A case 101 accommodates and supports the components of the molded case circuit breaker. The case 101 is formed in a substantially box shape. A handle 103 is exposed on an upper surface of the case 101. The handle 103 operates a switching mechanism 102 by a user's manual operation force.

Terminal portions 108, 109 capable of being connected to a power source or a load are provided on front and rear surfaces of the case 101. The terminal portions 108, 109 are provided for each phase (or for each pole). For example, in the case of a three-phase four-pole molded case circuit breaker, four terminal portions may be provided on the power source side and the load side, respectively.

Stationary contactors 105, 106 are fixedly provided inside the case 101. The stationary contactors 105, 106 are connected to the terminal portions 108, 109, respectively. In the case of a double molded case circuit breaker, the stationary contactors 105, 106 are provided on a power source side and a load side thereof, respectively. In other words, a power source side stationary contactor 105 and a load side stationary contactor 106 are provided. At this time, the power source side stationary contactor 105 may be directly connected to or integrally formed with the power source side terminal portion 108. The load side stationary contactor 106 may be connected to the load side terminal portion 109 through a trip mechanism (particularly, a heater 111).

In the vicinity of the contact unit (stationary contactor and movable contactor), an arc extinguishing unit (arc extinguishing device, arc chamber) 350 is provided to extinguish an arc generated during interruption. In the case of a double molded case circuit breaker (double circuit breaker), the arc extinguishing units 350 are provided on a power source side and a load side thereof, respectively. The arc extinguishing unit 350 includes a pair of side plates 351, 361 and a plurality of grids 370 coupled to the side plates 351, 361 at predetermined intervals.

A trip unit 110 that detects an abnormal current flowing through a circuit and tripping the switching mechanism is provided in a part of the case 101. The trip portion 110 is usually provided on the load side. The trip unit 110 may include a heater 111 connected to the load side terminal unit 109, a bimetal 112 coupled to the heater 111 to sense heat so as to be bent according to the amount of heat, a magnet 113 and an amateur 114 provided around the heater 111, a crossbar 115 provided to rotate by the contact of the bimetal 112 and the armature 114, and a shooter 116 restrained or released by the rotation of the crossbar 115 to restrain or release a nail (not shown) of the switching mechanism 102. Typically, the bimetal 112 is bent by heat generated from the heater 111 to rotate the crossbar 115 so as to operate the switching mechanism 102 during small current delay interruption, and the crossbar 115 rotates while the armature 114 is attracted by a magnetic force excited in the magnet 113 to operate the switching mechanism 102 during a large current during large current instant interruption.

The user's operation force is transferred to the switching mechanism 102 through the handle 103. A pair of rotation pins 104 are provided on the switching mechanism 102 to transfer the power of the switching mechanism 102 to each phase. The rotation pin 104 is formed to have a length across all phases and provided in the shaft assembly (or mover assembly) 120.

A base assembly case (briefly, base) 119 is provided. The base assembly case 119 may be formed by injection molding. The base assembly case 119 is formed approximately in the form of a box. The base assembly case 119 is provided with contact portions 105, 106, 122, 123 and an arc extinguishing unit 350. The switching mechanism 102 may be provided at a top of the base assembly case 119.

The shaft assembly 120 is provided. The shaft assembly 120 is provided with a rotation pin 104 passing therethrough. The shaft assembly 120 receives the switching power of the switching mechanism 102 by the rotation pin 104 to rotate. As the shaft assembly 120 rotates, the movable contactor 122, 123 also rotates to be brought into contact with or separated from the stationary contactors 105, 106.

The shaft assembly 120 includes a shaft body 121 and movable contacts 122, 123.

The shaft body 121 is formed in a cylindrical shape. A shaft 125 is disposed to protrude from both flat side surfaces (disk surfaces) of the shaft body 121. A pair of pinholes 126 through which the rotation pin 104 can be inserted are formed in the shaft body 121 in parallel to a direction of the shaft 125.

The movable contactors 122, 123 are rotatably provided on the shaft body 121. The movable contactor 122, 123 is brought into contact with or separated from the stationary contactors 105, 106 while rotating with the shaft body 121 or independently in a counterclockwise or clockwise direction to conduct or cut off the line.

Movable contacts 122a, 123a that can be brought into contact with the stationary contacts 105a, 106a of the stationary contactors 105, 106, respectively, are provided at both ends of the movable contactors 122, 123. The movable contacts 122a, 123a may be made of a material with excellent electrical conductivity and durability, such as a silver (Ag) alloy.

The movable contactor 122, 123 rotates together with the shaft body 121 in the case of a general small current or large current interruption situation, but the movable contactor 122, 123 rotates independently by a sudden electromagnetic repulsion force during cold current interruption. In this case, the movable contactor 122, 123 comes into contact with the shaft pin (not shown) of the shaft body 121 to stop the rotation.

Stationary contacts 105a, 106a are provided at both ends of the stationary contactors 105, 106, respectively. The stationary contacts 105a, 106a may be made of a material with excellent electrical conductivity and durability, such as a silver (Ag) alloy.

The arc extinguishing unit 350 is provided around the stationary contacts 105a, 106a of the stationary contactors 105, 106 and the movable contacts 122a, 123a of the movable contactors 122, 123.

The arc extinguishing unit 350 includes a side plate 351, 361 that forms a pair of side walls facing symmetrically and a grid 370 formed with a plurality of steel sheets to be inserted in parallel into the side plate 351, 361 at predetermined intervals. The arc extinguishing unit is surrounded by the side plate 351, 361 and the grid 370 to form an internal space capable of extinguishing an arc.

When the circuit is in a normal state, the stationary contacts 105a, 106a of the stationary contactors 105, 106 are connected to the movable contacts 122a, 123a of the movable contactors 122, 123 to allow current to flow. When an accident current occurs in the circuit, the movable contactors 122, 123 are rotated by the mechanism unit (not shown) to separate the movable contacts 122a, 123a from the stationary contacts 105a, 106a so as to cut off the current. At this time, an arc is generated between the movable contacts 122a, 123a and the stationary contacts 105a, 106a. The arc is divided into short arcs while entering between the grids 370 to increase an arc voltage. In addition, the arc voltage is further increased by an arc extinguishing gas, such as SF6, existing in the arc extinguishing unit. As a result, the arc is annihilated while suppressing the emission of free electrons.

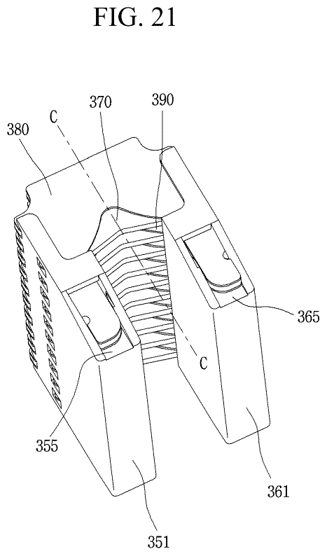

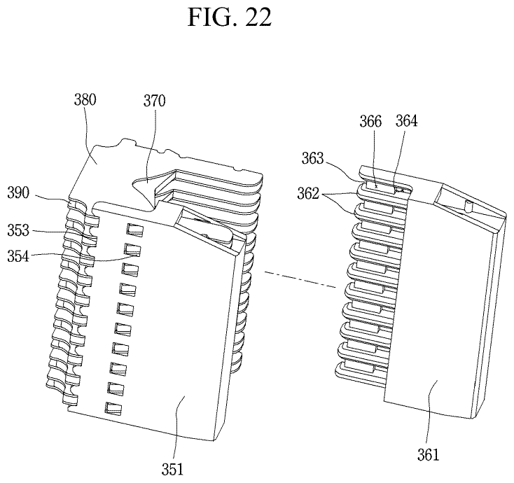

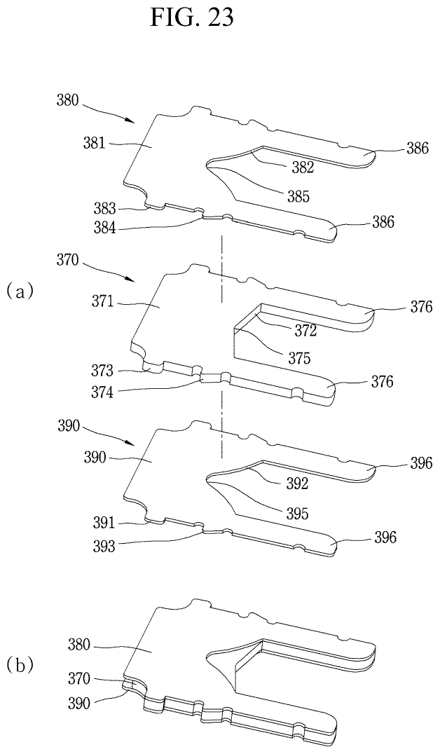

FIGS. 20 and 21 are perspective views, respectively, showing an arc extinguishing unit of a molded case circuit breaker according to an embodiment of the present disclosure, viewed from different directions. FIG. 22 shows a state in which one side plate is separated from the grid in an arc extinguishing unit of a molded case circuit breaker according to an embodiment of the present disclosure. FIG. 23 is a perspective view of a grid-insulator combination in FIG. 22.

The arc extinguishing unit 350 includes side plates 351, 361 and grid-insulator combinations 370, 380, 390.

A pair of symmetrical side plates 351, 361 are provided. The side plates 351, 361 are preferably made of an insulating material. That is, an arc generated at the time of interruption may be reflected from the side plates 351, 361 and collected by the grid-insulator combinations 370, 380, 390.

A plurality of fitting grooves 353, 363 and fitting holes 354, 364 to which the grid-insulator combinations 370, 380, 390 can be coupled are disposed in the side plates 351, 361.

The side plates 351, 361 are provided with coupling portions 355, 365 into which leg portions 376, 386, 396 of the grid-insulator combinations 370, 380, 390 are inserted.

The side plates 351, 361 are disposed to protrude from a plurality of support plates 352, 362, and the grid-insulator combinations 370, 380, 390 are inserted into the insertion grooves 356, 366 disposed between respective support plates 352, 362 and support plates 352, 362 adjacent thereto.

The grid-insulator combinations 370, 380, 390 are provided. Here, the insulation-insulator combinations 370, 380, 390 include grids 370 and insulating members 380.

The grids 370 are provided to attract and extinguish the arc. At this time, a plurality of grids 370 are provided on the pair of side plates 351, 361.

The grid 370 is formed as a flat plate. The grid 370 is preferably made of steel so as to attract the arc. A plurality of fitting protrusions 373, 374 are disposed to protrude from both side surfaces of grid 370 so as to be installed on the side plate 351, 361. The fitting protrusions 373, 374 of the grid 370 are fitted into the fitting holes 354, 364 and the fitting grooves 353, 363 of the side plates 351, 361. At this time, a caulking operation may be carried out for stable coupling.

The grid 370 is cut in a central portion of the front portion (a right portion in the drawing) to form an entry portion 372. The entry portion 372 provides a space in which the contact unit is disposed to operate so as to divide the arc. The entry portion 372 may be formed by a V-shaped groove, a U-shaped groove, or the like. Accordingly, arc division performance may be improved.

A plurality of grids 370 may be provided and installed at predetermined intervals in multiple layers on the side plates 351, 361. Accordingly, a passage through which the arc can pass is provided between the grids 370. A spacing when the grids 270, 280 are stacked may be set appropriately in consideration of the division and attraction force of an arc.

An adsorption grid 140 is provided to improve the attraction performance of the arc and absorb dust (see FIGS. 8 and 9). The adsorption grid 140 is provided at a top of the base assembly case 119. A fixing groove 118 into which the absorption grid 140 is fitted is disposed at the top of the base assembly case 119.

An exhaust plate 149 is provided. The exhaust plate 149 is provided behind the grid 370 to discharge arc gas and prevent foreign substances from intruding. A plurality of ventilation holes are formed in the exhaust plate 149.

The grid-insulator combinations 370, 380, 390 will be described in more detail.

The grid 370 is formed as a flat plate. The grid 370 is made of a material with excellent electrical conductivity, such as aluminum (Al).

The grid 370 includes a central plate portion 371 and a leg portion 376. The central plate portion 371 is a surface where an arc is divided and cooled while being attracted and entered.

A plurality fitting protrusions 373, 274 are spaced apart from one another and disposed to protrude from both side surfaces of the central plate portion 371 so as to be installed on the side plates 351, 261. The fitting protrusions 373, 274 of the grid 370 are fitted into the fitting grooves 353, 263 and the fitting holes 354, 264 of the side plates 351, 261. At this time, a caulking operation may be carried out for stable coupling.

An entry portion 372 into which a contact unit is inserted and an arc is sucked is disposed at a front portion of the central plate portion 371. The entry portion 372 is a surface where the arc A is attracted and initially brought into contact with the grid 370.

A central portion of the entry portion 372 of the central plate portion 371 is cut to form a cutout portion 375. The cutout portion 375 provides a space in which the contact unit can be operated to divide the arc. The cutout portion 375 may be formed by a V-shaped groove, a U-shaped groove, or the like. Accordingly, arc division performance may be improved.

The leg portions 376 are disposed to protrude from both sides of the entry portion 372 of the central plate portion 371, respectively. The leg portion 376 is inserted into and coupled to the coupling portions 355, 265 of the side plates 351, 261. Since the leg portion 376 is fixed to the coupling portions 355, 265 of the side plates 351, 261, the grid 370 remains stably coupled to the side plates 351, 261.

A first insulating member 380 is provided. The first insulating member 380 may be formed in the same or similar shape as that of the grid 370. The first insulating member 380 may be formed in the same shape as that of the grid 370 when viewed from the top.

The first insulating member 380 is disposed to have a thickness smaller than that of the grid 370. Accordingly, the grid 370 and the first insulating member 380 may be inserted together into the insertion grooves 356, 366 of the conventionally used side plates 351, 261 without changing the side plates 351, 261.

The first insulator 380 is formed as a flat plate. The first insulating member 380 is made of a material with excellent insulating properties.

The first insulating member 380 includes a first insulator central plate portion 381 and a first insulator leg portion 386. The first insulator central plate portion 381 is a surface where an arc is divided and cooled while being attracted and entered.

A plurality of first insulator fitting protrusions 383, 384 are spaced apart from one another and disposed to protrude from both side surfaces of the first insulator central plate portion 381 so as to be installed on the side plates 351, 261. The first insulator fitting protrusions 383, 384 of the first insulating member 380 are fitted into the fitting grooves 353, 263 and the fitting holes 354, 264 of the side plates 351, 261. At this time, a caulking operation may be carried out for stable coupling.

A first insulator entry portion 382 into which a contact unit is inserted and an arc is sucked is disposed at a front portion of the first insulator central plate portion 381. The first insulator entry portion 382 is a surface where the arc A is attracted and initially brought into contact with the first insulating member 380.

A central portion of the first insulator entry portion 382 of the first insulator central plate portion 381 is cut to form a first insulator cutout portion 385. The first insulator cutout portion 385 provides a space in which the contact unit can be operated to divide the arc. The first insulator cutout portion 385 may be formed by a V-shaped groove, a U-shaped groove, or the like. Accordingly, arc division performance may be improved.

The first insulator leg portions 386 are disposed to protrude from both sides of the first insulator entry portion 382 of the first insulator central plate portion 381, respectively. The first insulator leg portion 386 is inserted into and coupled to the cap portions 355, 265 of the side plates 351, 261. Since the first insulator leg portion 386 is fixed to the cap portions 355, 265 of the side plates 351, 261, the first insulating member 380 remains stably coupled to the side plates 351, 261.

The first insulating member 380 is disposed to have a thickness smaller than that of the grid 370.

The first insulating member 380 is coupled to a first surface (e.g., upper surface) of the grid 370.

A second insulating member 390 is provided. The second insulating member 390 may be formed in the same or similar shape as that of the grid 370. The second insulating member 390 may be formed in the same shape as that of the grid 370 when viewed from the top.

The second insulating member 390 is disposed to have a thickness smaller than that of the grid 370. Accordingly, the grid 370 and the second insulating member 390 may be inserted together into the insertion grooves 356, 266 of the conventionally used side plates 351, 261 without changing the side plates 351, 261.

The second insulator 390 is formed as a flat plate. The second insulating member 390 is made of a material with excellent insulating properties.

The second insulating member 390 includes a second insulator central plate portion 391 and a second insulator leg portion 396. The second insulator central plate portion 391 is a surface where an arc is divided and cooled while being attracted and entered.

A plurality of second insulator fitting protrusions 393, 394 are spaced apart from one another and disposed to protrude from both side surfaces of the second insulator central plate portion 391 so as to be installed on the side plates 351, 261. The second insulator fitting protrusions 393, 394 of the second insulating member 390 are fitted into the fitting grooves 353, 263 and the fitting holes 354, 264 of the side plates 351, 261. At this time, a caulking operation may be carried out for stable coupling.

A second insulator entry portion 392 into which a contact unit is inserted and an arc is sucked is disposed at a front portion of the second insulator central plate portion 391. The second insulator entry portion 392 is a surface where the arc A is attracted and initially brought into contact with the second insulating member 390.

A central portion of the second insulator entry portion 392 of the second insulator central plate portion 391 is cut to form a second insulator cutout portion 395. The second insulator cutout portion 395 provides a space in which the contact unit can be operated to divide the arc. The second insulator cutout portion 395 may be formed by a V-shaped groove, a U-shaped groove, or the like. Accordingly, arc division performance may be improved.

The second insulator leg portions 396 are disposed to protrude from both sides of the second insulator entry portion 392 of the second insulator central plate portion 391, respectively. The second insulator leg portion 396 is inserted into and coupled to the cap portions 355, 265 of the side plates 351, 261. Since the second insulator leg portion 396 is fixed to the cap portions 355, 265 of the side plates 351, 261, the second insulating member 390 remains stably coupled to the side plates 351, 261.

The second insulating member 390 is disposed to have a thickness smaller than that of the grid 370.

The second insulating member 390 is coupled to a second surface (e.g., lower surface) of the grid 370. Here, the first surface and the second surface may be surfaces facing each other.

The first insulating member 380 and the second insulating member 390 are disposed in parallel to the grid 370. That is, the first insulating member 380, the grid 370, and the second insulating member 390 may constitute three layers.

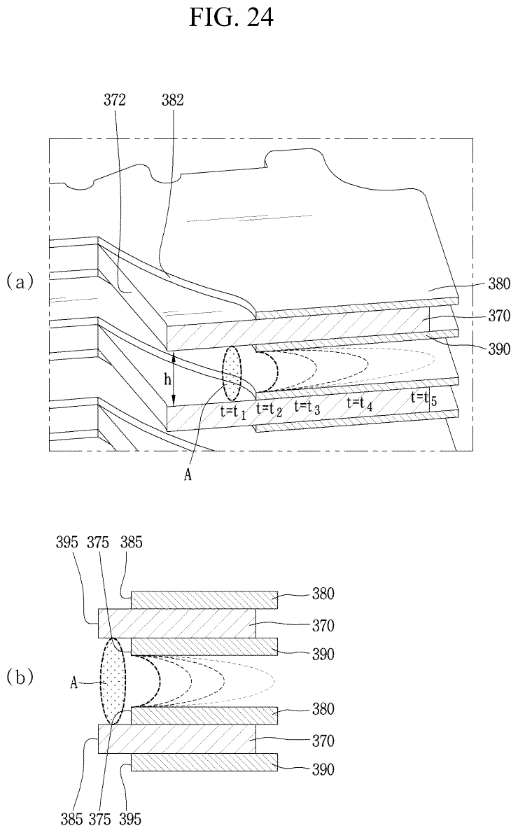

FIG. 24 shows a perspective view and a cross-sectional view cut along plane C-C in FIG. 21. There is shown an advancing state of the arc A during interruption.

Referring to a drawing shown in FIG. 24, at the beginning of interruption (t=t1), the arc A is attracted through the entry portions 372, 382, 392 of the grid-insulator combinations 370, 380, 390. The arc A is divided into intervals between the grid-insulator combinations 370, 380, 390. At this time, the arc A is divided into a size of h, which is a spacing between the grids 370 as shown in FIG. 12. Here, referring to any one divided arc A, it can be seen that an arc is divided to enter between the entry portions 372 or the cutout portions 375 of the grid 370.

The arc that enters the entry portion 372 or the cutout portion 375 of the grid 370 flows out to the rear of the grid 370 due to an internal pressure. There is shown that the arc A advances rearward over time while forming a ‘U’ shaped curve.

At this time, both ends of the arc A attracted into the entry portion 372 of the grid 370 are blocked by the first insulating member 380 or the second insulating member 390 so as not to advance, and only a middle portion of the arc A advances so as to extend in a‘U’ shape. Therefore, each divided arc A is effectively extended to improve interruption performance.

Accordingly, a likelihood of recurrence of the arc A at the rear of the grid 370 is reduced.

The entry portion 372 of the grid 370 extends (protrudes) forward from the entry portion 382 of the first insulating member 380 and the entry portion 392 of the second insulating member 390. Accordingly, there is no resistance when the arc A is attracted into the entry portion 372 of the grid 370 to be divided.

The cutout portion 375 of the grid 370 extends (protrudes) forward from the cutout portion 385 of the first insulating member 380 and the cutout portion 395 of the second insulating member 390. In other words, the cutout portion 385 of the first insulating member 380 and the cutout portion 395 of the second insulating member 390 are disposed to have deeper grooves than the cutout portion 375 of the grid 370. Accordingly, the arc A is easily attracted into the cutout portion 375 of the grid 370.

A first insulator rear portion of the first insulating member 380 and a second insulator rear portion of the second insulating member 390 extend (protrude) from a rear portion of the grid 370. That is, an insulating wall is formed between arcs flowing out of the rear of the grid 370, and thus a likelihood of recurrence of the arc A is reduced.

According to an arc extinguishing unit of a molded case circuit breaker according to an embodiment of the present disclosure, insulating members are provided on both sides of the grid, and as a result, both ends of an arc remain at an entry portion of the grid by the insulating members, and only a middle portion of the arc advances to the rear of the grid, and thus the arc extends well. Therefore, arc extinction is carried out efficiently.

Accordingly, a likelihood of arc recurrence is reduced.

Meanwhile, the heat capacity of the grid may be reduced to decrease a thickness of the grid.

The embodiments described above are embodiments implementing the present disclosure, and it will be apparent to those skilled in this art that various changes and modifications may be made thereto without departing from the gist of the present disclosure. Accordingly, it should be noted that the embodiments disclosed in the present disclosure are only illustrative and not limitative to the concept of the present disclosure, and the scope of the concept of the invention is not limited by those embodiments. In other words, the scope protected by the present disclosure should be construed by the accompanying claims, and all the technical concept within the equivalent scope of the invention should be construed to be included in the scope of the right of the present disclosure.

1. An arc extinguishing unit of a molded case circuit breaker, the arc distinguishing unit comprising:
a first side plate and a second side plate disposed to be spaced apart from each other by a predetermined distance;
a plurality of grids disposed at predetermined intervals between the first and second side plates; and
insulating members disposed in surface contact with the plurality of grids, respectively.

2. The arc distinguishing unit of claim 1, wherein the grids and the insulating members are alternately disposed with one another.

3. The arc distinguishing unit of claim 1, wherein the insulating member is formed in the same shape as that of the grid.

4. The arc distinguishing unit of claim 3, wherein a thickness of the insulating member is formed to be thinner than that of the grid.

5. The arc distinguishing unit of claim 4, wherein a lowermost insulating member among the plurality of grids and insulating members is disposed in surface contact with a lower surface of a lowermost grid, and the remaining insulating members among the plurality of grids and insulating members are disposed in surface contact with upper surfaces of the remaining grids.

6. The arc distinguishing unit of claim 1, wherein insertion grooves into which the grid and the insulating member are inserted together are disposed in the first and second side plates.

7. The arc distinguishing unit of claim 1, wherein an entry portion adjacent to a contact unit in the grid extends from an insulator entry portion adjacent to the contact unit in the insulating member.

8. An arc extinguishing unit of a molded case circuit breaker, the arc distinguishing unit comprising:
a first side plate and a second side plate disposed to be spaced apart from each other by a predetermined distance; and
a plurality of grid-insulator combinations disposed at predetermined intervals between the first and second side plates,
wherein the grid-insulator combinations comprise:
a plurality of grids disposed at predetermined intervals between the first and second side plates; and
insulating members coupled in surface contact with upper or lower surfaces of the plurality of grids, respectively.

9. An arc extinguishing unit of a molded case circuit breaker, the arc distinguishing unit comprising:
a first side plate and a second side plate disposed to be spaced apart from each other by a predetermined distance;
a plurality of grids disposed between the first and second side plates;
first insulating members disposed in surface contact with first surfaces of the plurality of grids, respectively; and
second insulating members disposed in surface contact with second surfaces of the plurality of grids, respectively.

10. The arc distinguishing unit of claim 9, wherein the first insulating member and the second insulating member are formed in the same shape as that of the grid.

11. The arc distinguishing unit of claim 9, wherein the first insulating member and the second insulating member are disposed to have a thickness smaller than that of the grid.

12. The arc distinguishing unit of claim 9, wherein the first insulating member and the second insulating member are disposed in parallel to the grid.

13. The arc distinguishing unit of claim 9, wherein insertion grooves into which the grid, the first insulating member, and the second insulating member are inserted together are disposed in the first and the second side plates.

14. The arc distinguishing unit of claim 9, wherein an entry portion or cutout portion facing a contact unit in the grid extends (protrudes) from a first insulator entry portion or first insulator cutout portion of the first insulating member and a second insulator entry portion or second insulator cutout portion of the second insulating member.

15. The arc distinguishing unit of claim 9, wherein a first insulator rear portion of the first insulating member and a second insulator rear portion of the second insulating member extend (protrude) from a rear portion of the grid.
